(19) United States
(12) Patent Application Publication
(10) Pub. No.: US 2016/0169207 A1
(43) Pub. Date: Jun. 16, 2016

(54) TRANSMISSION FOR A WIND TURBINE GENERATOR

(71) Applicant: VESTAS WIND SYSTEMS A/S, Aarhus N (DK)

(72) Inventors: Torben Friis Baun, Skodstrup (DK); Jesper Lykkegaard Neubauer, Hornslet (DK); Peter Lindholst, Hinnerup (DK)

(73) Assignee: VESTAS WIND SYSTEMS A/S, Aarhus N. (DK)

(21) Appl. No.: 14/903,756

(22) PCT Filed: Jun. 17, 2014
(86) PCT No.: PCT/DK2014/050172

§ 371 Date: Jan. 8, 2016

(30) Foreign Application Priority Data
Jul. 8, 2013 (DK) PA 2013 70381

(51) Int. Cl. F03D 11/00; F16H 55/50; F03D 9/00; F16H 7/04; F16H 7/08

(52) U.S. Cl. CPC F03D 11/02; F16H 7/04; F16H 55/50; F16H 7/08; F03D 9/002; F05B 2260/402

(57) ABSTRACT

The present invention relates to a rope-driven transmission for a wind turbine. The transmission comprises an input rotary member for being operatively connected to a rotor of a wind turbine and in rotational connection with at least one secondary shaft which is arranged in parallel with the rotational axis of said input rotary member, wherein said secondary shaft is adapted for operative connection with an output member of at least one electrical generator, wherein said rotational connection between said input rotary member and said at least one secondary shaft is provided by a rope, the course of said rope defining a rope path, and wherein said rope path includes a plurality of turns around said input rotary member and said secondary shaft. The transmission facilitates an easy monitoring and maintenance of the transmission. The invention further relates to a method of maintaining the transmission by replacing the rope. The invention further relates to a wind turbine generator comprising the transmission.

### FIELD OF THE INVENTION

The present invention relates to a transmission for a wind turbine generator. The present invention further relates to a method for maintaining such a transmission and a wind turbine generator comprising the same.

### BACKGROUND OF THE INVENTION

Wind turbines typically include a rotor with large blades driven by the wind. The blades convert the kinetic energy of the wind into rotational mechanical energy. The mechanical energy is typically transferred via a transmission to a generator, which then converts the energy into electrical power. Oftentimes it is necessary to increase the rotational speed of the rotor to the speed required by the generator. In these cases the transmission comprises a gearbox, which converts a low-speed, high-torque input from the rotor into a lower-torque, higher-speed output for the generator.

The large majority of wind turbines hold the transmission and generator in a nacelle on the top of a wind turbine tower. An alternative would be to transmit the torque through the tower; however, this is rarely used as this creates potential problematic issues with reaction torque in the tower structure from the rotating shaft. Consequently, most existing wind turbines comprise a complex and heavy transmission at the top of the wind turbine tower. Therefore, efforts have been put into trying to simplify the transmission, thereby obtaining easier maintenance and/or a lower weight.

One such attempt has been to use a belt to transmit the rotation from the rotor to a generator, which can be found e.g. in EP2391825. A disadvantage related to such solution, however, is that the belts, being subject to wear during use, will be expected to require a complicated and time-consuming replacement a number of times during the total life span of a wind turbine generator. Furthermore, it may be difficult to monitor when the time has come to replace the belt, and therefore it may be necessary to replace it more often than actually required to be on the safe side.

Therefore a need exists for an alternative solution to transmissions of the belt-type solution.

### SUMMARY OF THE INVENTION

The present invention relates to a transmission for a wind turbine comprising an input rotary member for being operatively connected to a rotor of a wind turbine and in rotational connection with at least one secondary shaft which is arranged in parallel with the rotational axis of said input rotary member, wherein said secondary shaft is adapted for operative connection with an output member of at least one electrical generator, wherein said rotational connection between said input rotary member and said at least one secondary shaft is provided by a rope, the course of said rope defining a rope path, and wherein said rope path includes a plurality of turns around said input rotary member and said secondary shaft.

With the present invention, an improved transmission has been obtained, for which a simpler monitoring and maintenance is made possible. The rope is the primary wear and tire part; and as the rope is relatively easy to monitor and maintain/replace as described herein, it is believed that the present invention provides an attractive improved transmission.

In an embodiment of the invention, said input rotary member is arranged on a main shaft of a wind turbine. In an embodiment of the invention, said input rotary member is arranged on a hub of a wind turbine. The input rotary member and the hub may be directly connected or they may be connected through a main shaft. In an embodiment of the invention, said secondary shaft is rotationally connected to said output member of said at least one electrical generator.

In an embodiment of the invention, said input rotary member is in rotational connection with at least two secondary shafts which are arranged in parallel with the rotational axis of said input rotary member and on opposite sides hereof. An embodiment with two secondary shafts is believed to provide suitable results with regard to rotational connection; therefore this embodiment has been chosen for illustration herein. However, embodiments with another number of secondary shafts are also within the scope of the present invention.

In an embodiment of the invention, said secondary shaft comprises circumferential grooves for guiding said rope. It should be noted that said grooves may be formed on the secondary shaft(s) or on possible roller mounted hereon, depending on the desired design of the transmission. It is believed that circumferential grooves on the secondary shaft(s)/rollers may be preferred in that they can be used to ensure suitable friction, but also to ensure that the individual turns of the rope are kept in place during operation.

In an embodiment of the invention, said input rotary member comprises circumferential grooves for guiding said rope. As well as for the secondary shaft(s), it is believed that circumferential grooves on the input rotary member may be preferred in that they can be used to ensure suitable friction. Due to the helical placing of the individual turns of the rope, a small angle may be present between possible circumferential grooves in said input rotary member and the rope. However, this angle is so small that is will not be problematic.

Furthermore, the present invention relates to a method of replacing a first rope of a transmission as described herein with a second rope, wherein said method comprises the steps of A) placing a replacement kit comprising a second rope in a suitable position in relation to said transmission; B) opening a joint of said first rope, thereby exposing two first rope ends; C) establishing a joint between one of said first rope ends and one end of said second rope; D) starting said transmission, thereby over time replacing said first rope with said second rope; E) stopping said transmission when said first rope has been replaced in said transmission; and F) jointing said one end of said second rope with the other end of the same.

Furthermore, the present invention relates to a wind turbine generator comprising a tower, a nacelle disposed adjacent a top of the tower, a rotor including a hub and at least one wind turbine blade extending from the hub, a generator, and a transmission disposed in the nacelle.

### BRIEF DESCRIPTION OF THE DRAWINGS

The invention will now be described in further detail with reference to the accompanying drawings in which

FIG. 1 is a partially torn away perspective view of a conventional wind turbine generator,

FIG. 2 shows a prior art belt-driven transmission for a wind turbine,

FIG. 3 shows a transmission according to an embodiment of the present invention,

FIGS. 4a and 4b show parts of secondary shafts to be used with a transmission according to embodiments of the invention, and

FIG. 5 shows a replacement kit for use with a transmission according to an embodiment of the invention.

### DETAILED DESCRIPTION OF THE DRAWINGS

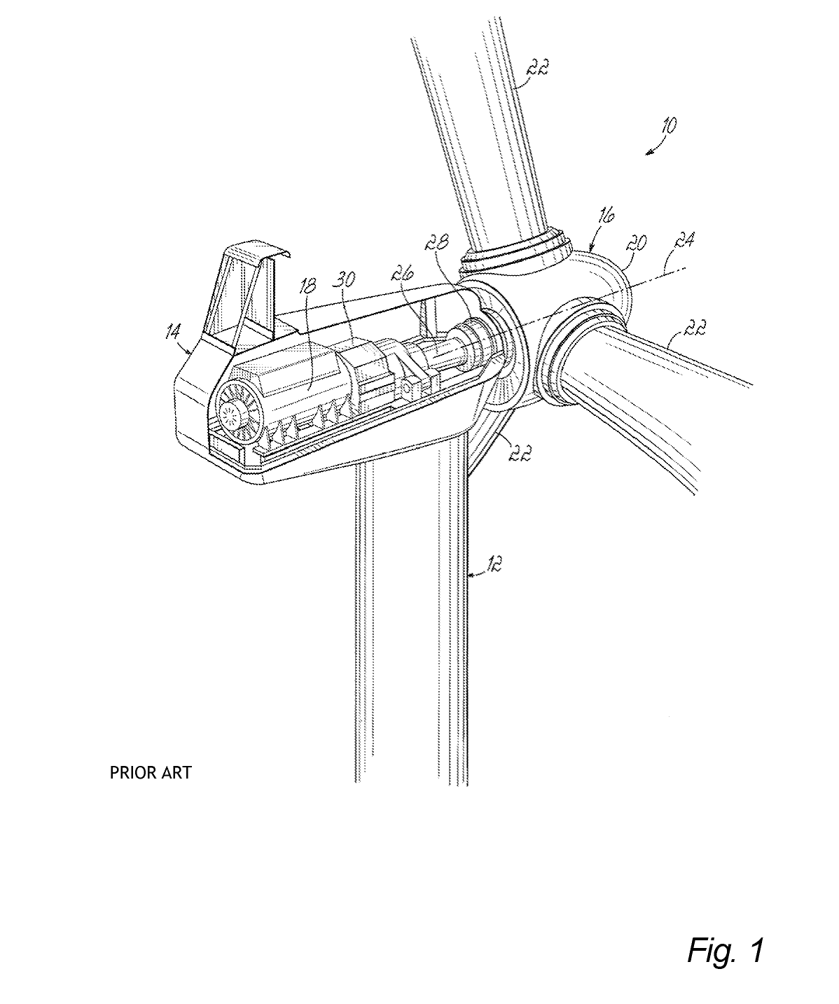

A conventional wind turbine is disclosed in FIG. 1. The wind turbine 10 includes a tower 12, a nacelle 14 disposed at the apex of the tower 12, and a rotor 16 operatively coupled to a generator 18 housed inside the nacelle 14. In addition to the generator 18, the nacelle 14 houses miscellaneous components required for converting wind energy into electrical energy and various components needed to operate, control, and optimize the performance of the wind turbine 10. The tower 12 supports the load presented by the nacelle 14, the rotor 16, the generator 18 and other components of the wind turbine 10 that are housed inside the nacelle 14. The tower 12 of the wind turbine 10 also operates to elevate the nacelle 14 and rotor 16 to a height above ground level or sea level, as may be the case, at which faster moving air currents of lower turbulence are typically found.

The rotor 16 of the wind turbine 10, which is represented as a horizontal-axis wind turbine, serves as the prime mover for the electromechanical system. Wind exceeding a minimum level will activate the rotor 16 and cause rotation in a direction substantially perpendicular to the wind direction. The rotor 16 of wind turbine 10 includes a central hub 20 and at least one blade 22 that projects outwardly from the central hub 20. In the representative embodiment, the rotor 16 includes three blades 22 at locations circumferentially distributed thereabout, but the number may vary. The blades 22 are configured to interact with the passing air flow to produce lift that causes the central hub 20 to spin about a longitudinal axis 24. The design and construction of the blades 22 are familiar to a person having ordinary skill in the art and will not be further described. For example, each of the blades 22 may be connected to the central hub 20 through a pitch mechanism (not shown) that allows the blades to pitch under control of a pitch controller.

The rotor 16 may be mounted on an end of a main shaft 26 that extends into the nacelle 14 and is rotatably supported therein by a main bearing assembly 28 coupled to the framework of the nacelle 14. The main shaft 26 is operatively coupled to one or more gear stages, which may be in the form of a gear box 30, to produce a more suitable mechanical input to the generator 18 located in the nacelle 14. The gear box 30 relies on various gear arrangements to provide speed and torque conversions from the rotation of the rotor and main shaft 26 to the rotation of a secondary drive shaft (not shown) that operates as an input to the generator 18.

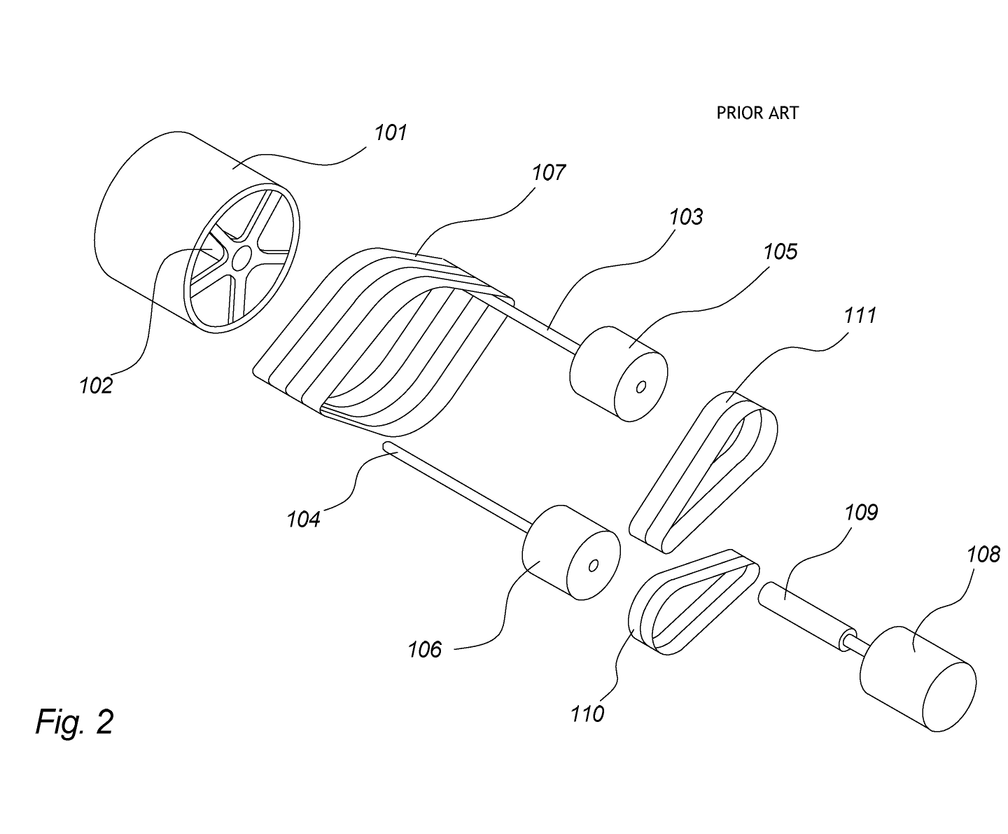

FIG. 2 shows an exploded view of a prior art belt-driven transmission for a wind turbine. The transmission comprises a large diameter roller 101 mounted on a main shaft 102 coupled to a rotor (not shown). Two secondary shafts 103 and 104 are mounted in parallel with the large diameter roller 101 and the main shaft 102. Each of these is fitted with a small belt roller 105, 106. A set of belts 107 extends around the large diameter roller 101 and the small belt rollers 105, 106 to transmit the rotation torque from the large roller 101 to the secondary shafts 103, 104. A generator 108 with generator shaft 109 in rotational connection with each of the small belt rollers 105, 106 via sets of belts 110, 111 is provided.

In essence a rotation of the rotor connected to the main shaft 102 of the wind turbine will create a rotation of the large diameter roller 101, the secondary shafts 103, 104 and ultimately the generator shaft 109. As the diameter of the large diameter roller 101 is much larger than that of the secondary shafts 103, 104, and likewise the diameter of the small belt rollers 105, 106 are much larger than that of the generator shaft 109, a two-step transfer of torque as shown here between main shaft 102 and generator shaft 109 creates a significant increase in rotational velocity. This shown prior art may provide advantages over a conventional gearbox type with respect to parameters such as size and weight. However, it still possesses potential difficulties, in particular in relation to replacing the drive belt.

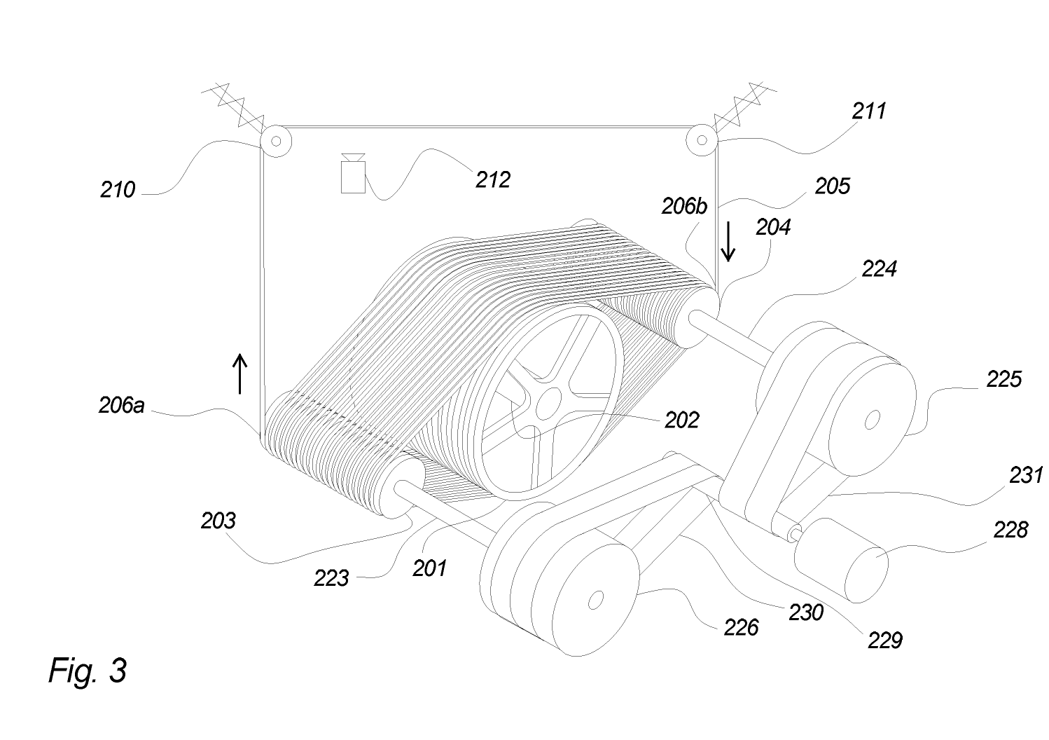

FIG. 3 shows a transmission according to an embodiment of the invention. A large diameter roller 201 is mounted on a main shaft 202 of the wind turbine generator and two secondary shafts 223, 224 with secondary rollers 203, 204 are mounted in parallel with the large roller 201 and the main shaft 202. An endless rope 205 is wound in a helical path over the first secondary roller 203, over the large diameter roller 201, over the second secondary roller 204, and then back again on the opposite side of the large diameter roller 201 and the two secondary rollers 203, 204, etc. Hereby is ensured that rotation of the large diameter roller 201 drives rotation of the secondary shafts 223, 224 by friction. In the shown embodiment, for the remaining parts of the transmission, a two-step transfer similar to the prior art of FIG. 2 is used, with each of the secondary shafts 223, 224 being fitted with a small belt roller 225, 226, and further with a generator 228 with generator shaft 229 in rotational connection with each of the small belt rollers 225, 226 via sets of belts 230, 231.

The helical mounting of the rope 205 will ultimately lead each rope section during operation towards a downstream end of the system, from where the rope is looped away from the large diameter roller, over pulleys 210, 211, and then again inserted into the upstream end of the system. Hereby the rope 205 performs a continuous movement during operation of the transmission, thereby defining a continuous rope path. The return loop of the rope is as such in this embodiment defined between a downstream end 206a of one secondary roller 203 to an upstream end 206b of another secondary roller 204.

Throughout the present disclosure, the term “rope” is intended to mean any flexible elongate member being little prone to fatigue and suitable for being wound around the rollers and transmitting forces as described in the embodiments herein. Thus, the term “rope” is to be taken, for example, to include wires and cables. In an embodiment of the invention, said rope comprises a material selected from the group consisting of natural fibres, synthetic fibres and metal wire. Rope may comprise a number of different long, stringy, fibrous material, some examples being PE-fibres, in particular Dyneema®, carbon fibres, and glass fibres. Rope may also be made partly or fully of metal, such as being a wire rope consisting of several strands of metal wire laid (or ‘twisted’) into a helix. If using a wire rope, preferably the metal would be steel. In general the skilled person in the art will appreciate which kinds of ropes will be suitable to establish a good rotational connection to be used in embodiments of the present transmission.

Apart from guiding the rope through the return loop, one or more of the pulleys 210, 211 may also be used to tension the rope 205. This feature may allow that the pulley systems continuously absorb possible short-scale variations in tension of the rope. Secondly the pulley systems may absorb a possible long-scale elongation of the rope. The pulleys may be floating and urged outwardly by resilient structures such as springs or the like. A detector 212 may advantageously be positioned in the return loop, which will be described more in detail later.

As mentioned, the rope 205 extends around the large diameter roller 201 and the secondary rollers 203, 204 to transmit the rotation torque from the large diameter roller 201 to the secondary shafts 223, 224. The number of turns of the rope 205 around the large diameter roller and the secondary rollers may vary dependent on the size of the rope and the maximum torque expected for the specific wind turbine model; however, as an example the number of turns could be about 100. For 100 turns and two secondary shafts as here shown, the torque on the main shaft or hub is transferred from the roller 201 to the secondary shafts 203, 204 through the tension in the rope, where no section of the rope experiences more than approximately 1/200 of the total force transferred. Thus, with a large number of turns the tension for each turn is reduced.

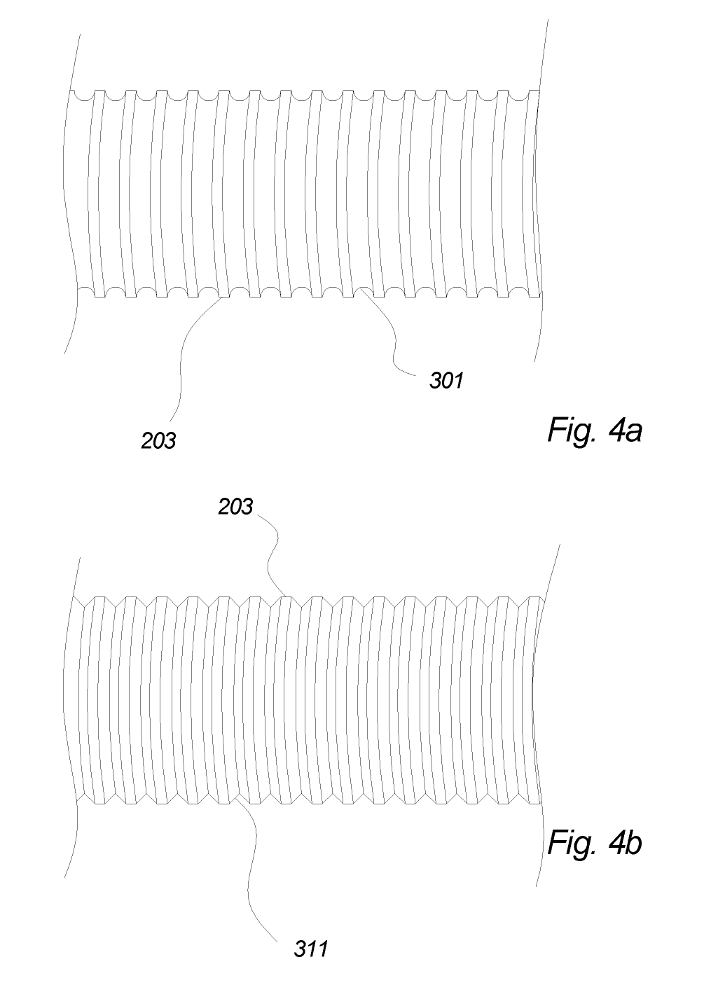

FIGS. 4a and 4b show parts of two different secondary rollers to be used according to some more preferred embodiments with which further advantages are obtained. It is preferred that the rope turns are well-aligned on the rollers and that the friction is optimized to ensure satisfactorily transfer of torque. As such, in preferred embodiments the secondary rollers 203, 204 may be provided with circumferential grooves 301, 311 around the roller adapted for guiding the rope. The grooves may be in any shape suitable for providing sufficient alignment and/or friction; examples may be semi-spherical- or V-shaped. The shown grooves 301, 311 are positioned equidistant, thereby ensuring a substantially side-to-side positioning of the rope on the large diameter roller and on the secondary shafts/rollers. Likewise grooves may also be formed on the large diameter roller 201 to improve friction between the large diameter roller 201 and the rope 205. In preferred embodiments, the grooves are on both the secondary shafts/rollers and on the large diameter roller.

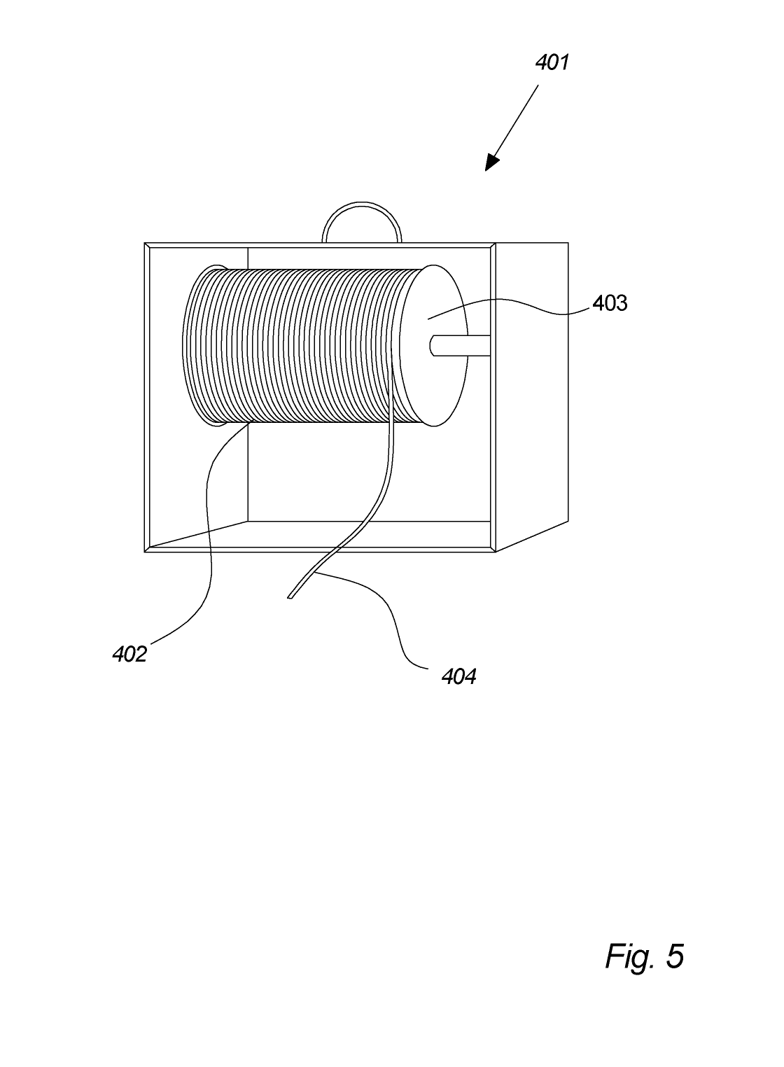

FIG. 5 shows a replacement kit 401 for use with a transmission according to an embodiment of the invention. When it is time for replacing the rope, a replacement kit 401 is brought to the nacelle. The replacement kit comprises a new rope 402, which will typically be wound up on a roller 403. When the replacement kit with a new rope with a free rope end 404 is positioned suitably in relation to the large diameter roller, the joint of the old rope is opened; thereby exposing two rope ends.

A new joint is made between the upstream end of the old rope and the free end of the new rope 404, and the transmission is started up, thereby slowly replacing the old rope with the new rope. The downstream end of the old rope may advantageously be connected to another transportable roller, such that it is wound up simultaneously with replacing the new rope. Once the full rope has been replaced, the transmission is stopped again, the two ends of the new rope are jointed and the wind turbine is ready to be started again. The old rope has been wound up and can easily be removed from the wind turbine. Ideally this substitution process of the rope may be carried out with no or at least only minimal need for dismantling of the transmission system.

In further rope-replacing embodiments of the invention, the first rope is in the replacement process simultaneously wound up on an empty roller and can easily be removed from the wind turbine afterwards. This may be obtained by attaching the other end of the first rope to said empty roller prior to starting the transmission to replace said rope.

In further rope-replacing embodiments of the invention, said replacement kit comprises a roller on which said second rope is wound up. In further rope-replacing embodiments of the invention, said replacement kit is hoisted to the nacelle of a wind turbine to obtain said suitable position in relation to an input rotary member of said transmission. According to an embodiment of the invention, the replacement kit may comprise two rollers, one for the old rope and another for the new rope.

As compared to conventional gearbox wind turbines, a large number of advantages may be found with using an input rotary member, such as a drum or a roller, and secondary shafts/rollers with a rope to transmit the torque. Some of these to be mentioned are a more compact structure, a more balanced torque over the transmission, and that the generation of power can be divided onto two or more generators if desired. Further, there may be a reduction of shock loads, the torque may be taken up over a large radius instead of a small radius inside a gearbox, and the manufacturing complexity of the transmission may be markedly reduced.

Further, with the present invention, a replacement of the rope only requires opening of a joint on the rope to be replaced, joining the upstream end of the rope to be replaced with an end of the new rope forming a temporary joint, and allowing the old rope to draw the new rope in place, before opening the temporary joint and joining the two ends of the new rope. Ideally, no adjustment of any other components will be necessary, and the maintenance/replacement can be carried out in a relatively easy and low time-consuming way.

A further advantage may be that with a rope, circumferential grooves in the rollers/shafts may be established for guiding the rope, thereby facilitating a larger possible contact surface between the rope and the roller. As friction is decided by surface area this means that the ability to transfer torque from the roller to the secondary shaft(s) may be improved.

In transmitting the torque between the rotary member and the generator shaft a two-step transfer with two intermediate steps is believed to be suitable. However, a single step or further steps may also be used in various embodiments. The rotational velocity will be increased for each step. Typically the rotational velocity is increased with a factor of about 5-10, such as 8 or 9, for each intermediate step. Hereby a total gearing can be adjusted as desired.

Throughout the present disclosure, the “input rotary member” may be any suitable member for the purpose known to a skilled person in the art, typically in the form of a drum or a roller. Throughout the present disclosure, the “output member of at least one electrical generator” will typically be in the form of a generator shaft.

With two parallel and diametrically opposite placed secondary shafts, or in general with the secondary shafts being arranged at the same angular distance to each other around the input rotary member, a symmetrical loading may be achieved. It should be noted though that although the use of two secondary shafts and one generator are shown in the figures and described here, within the scope of the invention the number of secondary shafts and generators could be varied independently between one to three or maybe more. For instance, instead of having two secondary shafts rotationally connected to a common output member of a generator, these can instead be connected to their own individual generators.

In an embodiment of the invention, said secondary shaft further comprises secondary roller. It should be noted that when stating secondary shafts herein, also within the scope of the invention are embodiments where secondary rollers are mounted on the secondary shafts.

In an embodiment of the invention, said rope path comprises a return loop section from a downstream end of said input rotary member or said at least one secondary shaft to an upstream end of said input rotary member or said at least one secondary shaft. In a preferred embodiment, said rope path comprises a return loop section from a downstream end of one of said at least two secondary shafts to an upstream end of one of said at least two secondary shafts.

The return loop section is used to allow the rope to run out in one end of the system and close the rope path by returning to the other end again. Hereby the rope path bypasses the input rotary member and the rope turns hereon. Further, in this return loop, the rope can be measured and/or cleaned before being fed into the system again.

As earlier mentioned, a detection system may advantageously be positioned in the return loop to continuously monitor the condition of the rope. If this detector observes initial fatigue in the rope, a replacement of the rope may be planned. If significant fatigue in the rope is observed, the wind turbine may be de-rated or even closed down until replacement of the rope has occurred.

In various embodiments, said detection system is capable of monitoring at least one parameter selected from the group consisting of rope diameter, rope slackness and density of broken fibres. If the detector observes an elongation of the rope e.g. through a slightly slacked rope path, the floating pulleys may absorb this to minimize any slacking of the rope on the roller and the secondary shafts. Further, for example an optical detector may observe changes in physical characteristics in general. In particular for rope comprising metal, the rope may be monitored for localised faults by inductive sensors and for distributed flaws by using Hall Effect sensors. Based on the specific set-up and rope type, the skilled person will be able to select a suitable detection system.

The use of rope in combination with said detector may provide a very distinct advantage. A continuous detection of damage may be carried out by one or more detectors detecting the rope with a diameter of maximum a few centimeters and easy accessible for observation from all sides, as compared e.g. to detecting belts moving along with a total width of maybe 1-2 meters and only easy accessible for observation from above. In this way an advantageous continuous observation of wear may be obtained, thereby facilitating that the instant level of wear may be known quite precisely and replacement can wait till it is really necessary.

In an embodiment of the invention, said transmission further comprises a cleaning system for cleaning said rope, preferably at a position in said return loop. Such cleaning system may be working to clean the rope continuously or in more preferred embodiments to clean the rope in full length at predetermined time intervals. How the cleaning will be performed will depend on which rope material is used, but in various embodiments e.g. air pressure, oil pressure or brushes may be used.

In an embodiment of the invention, said rope path includes at least 10 turns around said input rotary member and said secondary shafts. In further embodiments, the number of turns may be at least 20 or at least 50.

In an embodiment of the invention, said transmission comprises at least one rope-tensioning means, such as a pulley which may be floating optionally with resilient structures such as springs or the like to urge the pulley outwards, for tensioning said rope at at least one point in said return loop.

According to a further embodiment of the invention, said rotational connection between an output member of said at least one electrical generator and said secondary shafts is provided by at least one selected from the group consisting of belt-drive, gear and chain, and rope-drive. According to further embodiments, this rotational connection between an output member of said at least one electrical generator and said secondary shafts may also include a gearbox.

According to a further embodiment of the invention, the input rotary member is at least partly hollow. According to a further embodiment of the invention, the diameter of said input rotary member is at least 1 m, such as at least 2 m. According to a further embodiment the input rotary member is part of the main shaft.

According to a further embodiment of the invention, the length of said rope is at least 100 m, such as at least 200 m or at least 400 m. According to a further embodiment of the invention, said rope is one piece with one joint only. The skilled person in the art will appreciate which kinds of joints will be suitable to connect the ends of the rope in order to provide a suitable solution to the present transmission.

In further embodiments, the rope may comprise a surface adapted for improved transfer of torque. It may comprise a rough surface or be equipped with teeth, thereby resembling a toothed belt. For a toothed belt embodiment with a plurality of turns around the input rotary member and secondary shafts, said input rotary member further comprises axial grooves matching such that the teeth can grab into the grooves.

While the present invention has been illustrated by a description of various preferred embodiments and while these embodiments have been described in some detail, it is not the intention of the applicant to restrict or in any way limit the scope of the appended claims to such detail. Additional advantages and modifications will readily appear to those skilled in the art.

1. A transmission for a wind turbine comprising an input rotary member for being operatively connected to a rotor of a wind turbine and in rotational connection with at least one secondary shaft which is arranged in parallel with the rotational axis of said input rotary member,
wherein said secondary shaft is adapted for operative connection with an output member of at least one electrical generator,
wherein said rotational connection between said input rotary member and said at least one secondary shaft is provided by a rope, the course of said rope defining a rope path, and
wherein said rope path includes a plurality of turns around said input rotary member and said secondary shaft.

2. The transmission for a wind turbine according to claim 1, wherein said input rotary member is arranged on a main shaft of a wind turbine.

3. The transmission for a wind turbine according to claim 1, wherein said input rotary member is arranged on a hub of a wind turbine.

4. The transmission for a wind turbine according to claim 1, wherein said secondary shaft is rotationally connected to said output member of said at least one electrical generator.

5. The transmission for a wind turbine according to claim 1, wherein said input rotary member is in rotational connection with at least two secondary shafts which are arranged in parallel with the rotational axis of said input rotary member and on opposite sides hereof.

6. The transmission for a wind turbine according to claim 1, wherein said secondary shaft comprises circumferential grooves for guiding said rope.

7. The transmission for a wind turbine according to claim 1, wherein said input rotary member comprises circumferential grooves for guiding said rope.

8. The transmission for a wind turbine according to claim 1, wherein said secondary shaft further comprises a secondary roller.

9. The transmission for a wind turbine according to claim 1, wherein said rope path comprises a return loop from a downstream end of said input rotary member or said at least one secondary shaft to an upstream end of said input rotary member or said at least one secondary shaft.

10. The transmission for a wind turbine according to claim 1, wherein said transmission further comprises a detection system to monitor the condition of said rope.

11. The transmission for a wind turbine according to claim 1, wherein said transmission further comprises a cleaning system for cleaning said rope.

12. The transmission for a wind turbine according to claim 10, wherein said detection system is capable of monitoring at least one parameter selected from the group consisting of rope diameter, rope slackness and density of broken fibres.

13. The transmission for a wind turbine according to claim 1, wherein said rope path includes at least 10 turns around said input rotary member and said secondary shafts.

14. The transmission for a wind turbine according to claim 1, wherein said rope comprises a material selected from the group consisting of natural fibres, synthetic fibres and metal wire.

15. The transmission for a wind turbine according to claim 9, wherein said transmission comprises at least one rope-tensioning means for tensioning said rope at least one point in said return loop.

16. A method of replacing a first rope of a transmission as described in claim 1 with a second rope, wherein said method comprises the steps of
A) placing a replacement kit comprising a second rope in a suitable position in relation to said transmission;
B) opening a joint of said first rope, thereby exposing two first rope ends;
C) establishing a joint between one of said first rope ends and one end of said second rope;
D) starting said transmission, thereby over time replacing said first rope with said second rope;
E) stopping said transmission when said first rope has been replaced in said transmission; and
F) jointing said one end of said second rope with the other end of the same.

17. A wind turbine generator comprising:
a tower;
a nacelle disposed adjacent a top of the tower;
a rotor including a hub and at least one wind turbine blade extending from the hub;
a generator; and
a transmission disposed in the nacelle according to claim 1.
